(19) United States
(12) Patent Application Publication
(10) Pub. No.: US 2002/0006826 A1
(43) Pub. Date: Jan. 17, 2002

(54) System for playing a game

(76) Inventor: Ole Hansted, Frederiksberg (DK)

Correspondence Address: BIRCH STEWART KOLASCH & BIRCH, PO BOX 747, FALLS CHURCH, VA, 22040-0747, US

(21) Appl. No.: 09/835,852

(22) Filed: Apr. 17, 2001

Related U.S. Application Data
(60) Provisional application No. 60/198,134, filed on Apr. 17, 2000.

(51) Int. Cl. G06F 17/00

(52) U.S. Cl. 463/42

(57) ABSTRACT

A system for a plurality of persons playing a game, the system comprising a central data processing unit, a portable communication unit for each person, each communication unit being adapted to receive game information and transmit this information to the central data processing unit, the central data processing unit being adapted to transmit information received from one communication unit to at least one other of the communication units, the central data processing unit being adapted to receive information from each of a number of persons relating to a desired starting point in time for a game, and compare the received information and inform respective persons if a correspondence is found.

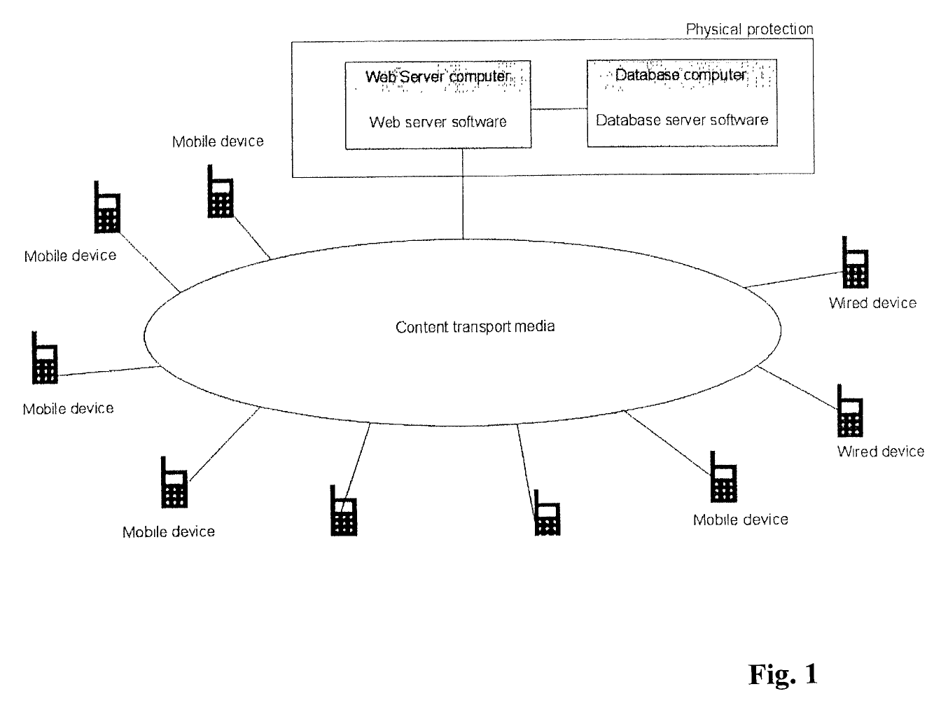

The present invention relates to a system for playing a game and more particularly for a plurality of persons playing the same game with or against each other.

A number of systems are known for persons playing a game together. Systems are also known for enabling persons to play together even though they are at different locations—such as computer chess over the Internet.

Also, e.g. electronic golf systems are known, see Born, U.S. Pat. No. 5,949,679, where golf players are able to enter the score at each hole in order for a common server to keep score in the individual games. Also, in this system, alternative competitions are played between competitors not actually playing together (but being at the same golf course at the same point in time).

However, these systems have limitations by the fact that the score entering “computers” are not portable but are stationary in different senses. Also in the prior art systems, the games are played between competitors which are at the same course or which are predefined prior to the game.

The present invention relates to a less limiting manner of playing a game. In a first aspect, the invention relates to a system for a plurality of persons playing a game, the system comprising

a central data processing unit,

a portable communication unit for each person, each communication unit being adapted to receive game information and transmit this information to the central data processing unit,

the central data processing unit being adapted to transmit information received from one communication unit to at least one other of the communication units,

the central data processing unit being adapted to:

receive information from each of a number of persons relating to a desired starting point in time for a game, and

compare the received information and inform respective persons if a correspondence is found.

In the present and following aspects, the central data processing unit is a processing unit, which may be central, decentralised, comprising any number of computers etc. The main operation of this unit is the receiving, optional processing, optional storing, and transmission of data. It is advantageous that the data from at least those communication units relating to persons playing the same game actually communicate with the same central processing unit.

Also, “portable” will in this and the following aspects mean that the unit may be carried by the person while playing the game. If the game is a game of golf, the person or group of persons may carry the unit instead of units being positioned at positions along the course.

“game information” is information relating to the game and normally information relating to a present “state” of the game or a recent development/event of/in the game.

This aspect of the invention relates to a “dating service” where persons wishing to play a game now or in the future may inform the central data processing unit of the point in time in which he/they wish to play. The central unit will then compare this information to information from other persons/groups of persons and inform respective parties if the desired points in time at least substantially coincide,

Naturally, the persons may be informed that someone else wishes to play a game not at the same point in time but maybe 12-2 hours earlier or later. Then, if the person wishes to alter the desired point in time in order to play the game, he may return with information to that fact.

In this manner, any two persons not knowing each other may in fact play the game over any distance due to this manner of identifying the players.

It may be desired that it is the portable communication units which are adapted to provide to the central data processing unit information relating to a desired starting point in time for a game for a person and to receive from the central data processing unit information relating to another person wishing to play the game at at least approximately that point in time.

In addition to the timing information, the information provided by the portable unit might comprise information relating to the desired game or a desired other player of the game. The information may relate to which type of player with whom it is desired to play. This information may relate to gender, age, social status, marital status, income, the person's skills (e.g. golf handicap), which arena to use, political status, religion, and/or nationality. Also, the information may relate to where the person wishes to play the game, such as in the same place, such as the same course, or at a predetermined position/course.

In a second aspect, the invention relates to a system for a plurality of persons playing a (common) game, the system comprising

a central data processing unit,

a portable communication unit for each person or group of persons, each communication unit being adapted to receive game information and transmit this information to the central data processing unit,

the central data processing unit being adapted to transmit information received from one communication unit to at least one other of the communication units,

a portable communication unit being adapted to, before initiating a game or the taking part therein by a person or a group of persons, request the entering of starting information by the person or group of persons,

wherein a plurality of persons or a group of persons may play concurrently using the same communication unit by each person or group of persons entering non-identical starting information.

In this manner, the same portable communication unit may be used by a plurality of persons or groups of persons even though they represent different parties of the game. Normally, this would be applicable if the persons/groups attended the game at the same place in order for e.g. one person to enter/input the information for both parties.

Normally, starting data comprise a password and optionally user identification—both pieces of information are checked at the central unit in order to verify the applicability and permission of the individual persons/groups.

Preferably, the starting information will identify a specific part of the central data processing unit where information from the portable communication unit and relating to the person or group of persons relating to the starting information is stored and where data relating to the actual person or groups of persons may be derived. Thus, even though the same communication unit is used, different data may be stored and derived for different persons or groups of persons.

In a third aspect, the invention relates to a system for a plurality of persons playing a game, the system comprising

a central data processing unit,

a portable communication unit for each person or group of persons, each communication unit being adapted to receive game information and transmit this information to the central data processing unit, (the game information relating to a recent event/development in the game)

the central data processing unit being adapted to, for each of a number of events of the game:

receive and process game information from the portable units,

determine one or more possible subsequent/next event(s) (actions/scores/events of the persons) of the game and which person or persons may perform this/these events,

provide user interface data relating to this/these event(s), and

transmit, to at least one portable unit of the person or persons information relating to the possible next events, the user information enabling this/those portable unit(s) to:

illustrate to the person(s) the determined next/subsequent event(s) and to

receive, by a single push operation of a person, information relating to the actual next/subsequent event of the game and transmitting this game information to the central data processing unit

Thus, the central unit processes the information received and determines which events are possible at this stage of the game. If the game was a soccer game, either team may score, whereby the portable unit may reflect these possible events. If the game was golf, the order of striking of the players is ordered, whereby the fact that one player has e.g. putted the ball into the hole will define that the other player gets to strike his ball.

Thus, the invention relates to several aspects which may be combined in order to achieve a system highly useful when a number of independent players wish to play a game.

Normally, the game information would relate to specific predetermined events of the game, such as changes in score, such as goals. Also, it may be preferred to be able to input information as to how and who scored. However, also less “important” information may be input, such as penalty kick, throw-in, hole in one, ball to green, ball in the bunker, person expelled from the court/field, etc. The operator of the system would normally enable the system to handle this type of information. However, the user may be able to select between different manners of degrees of detail of the information input.

Preferably, the central data processing unit is further adapted to provide, with the data relating to a next/subsequent event, data relating to an actual score of the game. In this manner, the portable units are not merely inputting devices but also inform players of the score.

Alternatively or optionally, the central data processing unit is adapted to transmit alternative information, such as an advertisement, to portable units not relating to the person(s) which may perform the next/subsequent event of the game. In this manner, mobile units relating to persons who cannot cause events to happen (in games where a specified order of events exists -such as in golf or chess) will be exposed to e.g. advertisements. Optionally, the actual score may also be showed on the mobile unit.

In a number of situations, the central data processing unit may further be adapted to store received game information. This may be due to others subsequently wishing to recapitulate the game or for e.g. preparing statistical information relating to the game or a number of games—such statistics optionally being provided by the central unit. These statistics may relate to the game or any of the information input such as the number of goals made by a person, the number of penalty kicks, the number of holes in one at a specific court and/or a specific hole.

Also, the central data processing unit may further be adapted to retrieve and transmit (during a game) stored game information relating to an earlier game This enables e.g. a single person playing the game, such as golf, to actually play himself (a specific earlier game) by receiving the information of the earlier round while scoring his own round.

An interesting aspect is one where the central data processing unit further adapted to transmit game information to additional receivers, such as PC, a palm pilot or a mobile telephone, whereby scoring data may be provided to interesting parties via e.g. the internet.

In a fourth aspect, the invention relates to a mobile communication unit for use in the above aspects of the system, the unit comprising:

means for entering and transmitting game information to the central data processing unit,

means for receiving and displaying (game) information from the central data processing unit.

This unit may be e.g. a mobile telephone, such as a WAP telephone.

The unit may further comprise:

means for entering and transmitting (to the central data processing unit) information relating to a desired starting point in time for a game, and

means for receiving information from the central data processing unit relating to whether another communication unit/user has desired a game at at least approximately that point in time. In this manner, the unit is able to perform the “dating service”. The advantage of having the mobile unit perform this service is the fact that the user may then “order” the game at any time.

Additionally or optionally, the unit may additionally be adapted to receive and display additional information, such as advertisements. This advertisement may be displayed until a new score has been entered or simply in a predetermined period of time.

Preferably, the unit is adapted to have information entered by a single button push whereby a single button push will enter the information and transmit this to the central unit.

In the following, the invention will be described with reference to the drawing.

Component Description

To run the system the following components are needed:

A server computer running web server software (e.g. Apache, IIS), supporting server side scripting (e.g. PHP, ASP, Java serviets)

A database computer running database server software (e.g. Oracle, MySql, Sybase) Database software may be running on the same machine as web server software or have a direct connection to it.

One or more mobile devices that may read a content written in special markup languages designed for low bandwidth, limited display, limited user input facilities and limited memory devices (e.g. HDML, WML). A mobile device may be a mobile phone, PDA, portable computer. It may also be an emulating software e.g. Nokia WAP Toolkit, WinWap, as well as online web emulators e.g. Wapmore Wapemulator.

Content transport media between mobile device and web server machine. This connection may be wireless or wired and may involve many interconnecting devices and protocols, which are transparent for the user interface and web server software. Content transport media may contain e.g. Internet, Ethernet (IEEE 802.3).

The system may also consist of one or more wired devices that may read a content written in Hypertext Markup Language (HTML). A wired device may be e.g. personal computer running web browser (Microsoft Internet Explorer, Netscape Navigator, etc.) or a cellular phone with HTML browser capability (e.g. Nokia communicator). For using a wired device, the content transport media between web server machine and a wired device is required.

General Login Procedure

in order to use a system the user has to be recognised by the server software. The user has assigned a unique username within the system and a password of his choice. Above assignment procedure may be done e.g. by the set of script programs that are accessible through a mobile device or a wired device. The user data are stored within the database server software (the software maintain the actual location and format of the stored data).

We describe the user as logged if the request from a wired or mobile device, that he is operating, contains the information sufficient to find corresponding user data in the database software. In other cases the user is not logged.

The user become logged into the system using the following main login procedure:

1. User #1 using his wired or mobile device sends a request to the server software for the main login page.

2. Server software receives an request and do the following:

generates the random string (session identifier) and store it in the database table together with the timestamp. The session identifier can be e.g. 32 characters string containing characters taken from the set ‘0123456789abcef’ generated as MD5 hash of the polynomial function of the current web server time (with milliseconds accuracy) and rational number taken from the pseudo-random sequence.

sends a response to the user wired or mobile device containing main login page layout for the user and a generated session identifier. The login page shall be constructed in such a way that user can input his username and password, then device shall be able to send a request to the server software containing username, password and the session identifier.

3. User#1 using the main login page inputs his username and password and requests the entrance page. The request is being send to the server software and contain username, password and session identifier.

4. Server software receives the request and do the following:

checks if the combination of username and password is found in the database table containing users of the system. If no valid combination is found, the server software responds as in the point 2.

checks If the request contains the session identifier and if it is found in the database table of generated session identifiers. Additionally it checks if the timestamp related to the given identifier is not older than some specific time. If non of these conditions are fulfilled the server software responds as in the point 2.

relates the username in the database software to the session identifier.

responds to the mobile device with the entrance page layout, containing the further choices and some personalised information (e.g. user full name as specified in the assignment procedure)

5. User #1 receives the entrance page layout. Using this page he can choose to start a game (see display of results and scoring of the game), invite another user for a game (see invitation procedure) or login another user using the same wired or mobile device.

6. For the following pages the session identifier is transmitted with every request from the user device. This way the server software is able to relate it to the particular user. The password is not transmitted over the transport media. The request containing a valid session identifier causes server software to update timestamp related to the given session identifier.

7. Session identifiers that have timestamp older than some specific time are periodically removed from the database.

8. For every request from the particular user, the system checks if there are some items concerning him in the event queue and takes appropriate actions if necessary (see event queue).

9. Every page which is send as a response from the server software to the users wired or mobile device contains the information that causes this page to be refreshed from the server after some specific period (e.g. 30 seconds). This mechanism gives us the possibility to process events stored in the event queue even if the user doesn't take any action.

Multiple Login Procedure

Another user can be logged using the same wired or mobile device. In such a case the server software relates session identifier to both usernames stored in the database. Many users may be logged in this way.

The second user (#2) can be logged in using the following multiple login procedure:

1. User #1 requests multiple login page using his wired or mobile device.

2. Server software receives the request and checks if it contains a valid (stored in the database of session identifiers and having the timestamp not older than some specific time) session identifier. If the session identifier is not valid it responds as in the point 2 of the general login procedure

3. Server software sends a response to the wired or mobile device containing multiple login page layout. The multiple login page shall be constructed in such a way that user #2 can input his username and password, then device shall be able to send a request to the server software containing username, password and the session identifier

4. User #2 using the multiple login page inputs his username and password and requests the entrance page. The request is being send to the server software and contain username, password and session identifier.

5. Server software receives the request and do the following:

checks if the combination of username and password is found in the database table containing users of the system. If no valid combination is found, the server software responds with the multiple login form as in the point 3.

checks if the request contains the session identifier and if it is found in the database table of generated session identifiers. Additionally it checks if the timestamp related to the given identifier is not older than some specific time. If non of these conditions are fulfilled then the server software responds as in the point 2 of the general login procedure.

relates the username of the user #2 in the database software to the session identifier.

responds to the mobile device with the entrance page layout, containing the further choices and some personalised information for both users (e.g. user full names as specified in the assignment procedure)

6 Users #1 and #2 receive the entrance page layout. Using this page they can choose to start a game (see display of results and scoring of the game), invite another user for a game (see invitation procedure) or login next user using the same wired or mobile device

7. For the following pages the session identifier is transmitted with every request from the user device. This way the server software is able to relate it to the particular users. Passwords are not transmitted over the transport media.

8 It is implicitly assumed that all users using the same wired or mobile device play the same match with the same rules.

Invitation Procedure

The logged user or users using their mobile or wired device can invite other users (not logged on the same device) to the common game.

User or users using the mobile or wired device initiate the procedure by requesting main invitation page. The server software in case of any request checks the validity of the session identifier as described in general login procedure. If the request is valid then user can choose among the following types of invitation:

a. specific person invitation—allows to check if the specified person (described using username) is logged into the system. The invited person receives an invitation, can accept or reject it. In case of acceptance, the system relate both (or more) usernames as playing the same match.

It is also possible to invite a specific person, who is not logged—in such case the person invited must log in and accept invitation before a game is set up.

b. specific group invitation—allows to check if any of the users in well specified (by usemames, e.g. during assignment procedure) group is currently logged into the system, choose among them and invite to the game.

It is also possible to invite persons, who are not logged—in such case the persons invited must log in and accept invitation before a game is set up.

c. limited open invitation—allows to send an invitation to the users currently logged into the system, that matches the desired criteria e.g. are within same age group or play the same course.

It is also possible to invite persons, who are not logged—in such case the persons invited must log in and accept invitation before a game is set up.

d. open invitation—allows to send an invitation for some number of randomly chosen users currently logged into the system.

It is also possible to invite persons, who are not logged—in such case the persons invited must log in and accept invitation before a game is set up.

A user can decide if he want to receive invitations of any of the above types. There may be also the option to have a personal list of usernames from which the user wants to receive invitations.

Specific Person Invitation Procedure:

1. Any of the users of the mobile device requests a search for a particular username by requesting specific person search page and including desired username in the request. The system provides a user with a page for that purpose having a space for username input.

2. Server software receives the request and process the following:

checks if the desired username is related to valid session identifier. If not, then responds with the information that desired user is not logged to the system.

In such case the choice can be made, that the invitation is forwarded via email or via a notification for the invited user the first time he/she logs in. It can in such invitation be stated any time and place for the game to take place—as long as the game will be in the future After the time of the game, the invitation will automatically be cancelled.

inserts into the event queue the information that desired user has got an invitation from the particular user.

responds with the information that the invitation has been send.

3. The mechanism of the event queue assures that the invitation will be displayed on the desired user device within short period of time.

4. Desired user can accept or reject the invitation. His choice will be send to the server software, which will process and store obtained information in the event queue.

5. If desired user confirmed the invitation then server software relate username of the desired user with the game currently played by the user.

6. The user get the confirmation or rejection of his invitation using event queue mechanism.

7. A special variation to this invitation is the personal played match invitation, where the user invites from a catalogue of played matches. This may be one of his own old matches or another match on the field. Thus the process is fundamentally the same, but the scored data is taken from the old database instead of being transmitted from the opponent somewhere in the field.

Specific Group Invitation Procedure

1. Any of the users of the mobile device requests a search for a particular group by requesting specific group search page and including desired groupname in the request. The system provides a user with a page for that purpose having a space for groupname input or a list of groups related to any of users logged on this device. The mentioned list may be created e.g. as a part of assignment procedure.

2. Server software receives the request and process the following:

checks if the desired groupname is related to any of the users logged on this device, by checking the database table responsible for that relationship. If no relation is found, then responds with the information that desired groupname is not defined.

checks if any of the user of the desired group is logged into the system (has valid related session identifier). If no user of the desired group is logged then the responds with the suitable information.

for every logged user in the desired group inserts into the event queue the information that user of the desired group has got an invitation from the particular user

responds with the information that the invitation has been send. The information contains usernames and/or number of actually invited users.

3. The mechanism of the event queue assures that the invitation will be displayed on the device of every logged user of the desired group within short period of time.

4. Desired user can accept or reject the invitation. His choice will be send to the server software, which will process and store obtained information in the event queue.

5. If desired user confirmed the invitation then server software relate username of the desired user with the game currently played by the user.

6. The user get the confirmation or rejection of his invitation using event queue mechanism.

Limited Open Invitation Procedure.

1. Any of the users of the mobile device requests a search for any opponent logged into the system and matching the specified criteria. The choice of criteria may be done via hierarchical set of links or may be a choice from the set of already prepared (e.g. during assignment procedure) sets of options. There exist a special normalisation table. In this table the system keeps the information that relates two disciplines and allows recalculation of the current user score to some normalised score (see normalised score concept). There may be or may not be a record for each discipline pair.

2. Server software receives the request and process the following:

checks if there is at least one user logged into the system that matches desired criteria. provided his and requesting user discipline have the corresponding record in the normalisation table. If no user is found, then responds with the suitable information.

randomly choose one of the users (desired user) that match above criteria.

inserts into the event queue the information that desired user has got an invitation from the particular user.

responds with the information that the invitation has been send.

3. The mechanism of the event queue assures that the invitation will be displayed on the desired user device within short period of time.

4. Desired user can accept or reject the invitation. His choice will be send to the server software, which will process and store obtained information in the event queue.

5. If desired user confirmed the invitation then server software relate username of the desired user with the game currently played by the user.

6. The user get the confirmation or rejection of his invitation using event queue mechanism.

Open Invitation Procedure.

1. Any of the users of the mobile device requests a search for any opponent logged into the system. The invitation is not limited to the particular sport discipline, sex, age etc. There exist a special normalisation table. In this table the system keeps the information that relates two disciplines and allows recalculation of the current user score to some normalised score (see normalised score concept). There may be or may not be a record for each discipline pair.

2. Server software receives the request and processes the following:

checks if there is at least one user logged into the system, that plays the same discipline or play different discipline provided his and requesting user discipline have the corresponding record in the normalisation table. If no user is found, then responds with the suitable information.

randomly choose one of the users (desired user) that match above criteria.

inserts into the event queue the information that desired user has got an invitation from the particular user.

responds with the information that the invitation has been send.

3. The mechanism of the event queue assures that the invitation will be displayed on the desired user device within short period of time.

4. Desired user can accept or reject the invitation His choice will be sent to the server software, which wilt process and store obtained information in the event queue.

5. If desired user confirmed the invitation then server software relates username of the desired user with the game currently played by the user.

6. The user gets the confirmation or rejection of his invitation using event queue mechanism

Display of Results and Scoring of the Game

I. Choosing Options

Logged user (or users, when using multiple login procedure) can choose desired sport, playground, match and scoring system using two methods;

1. choosing through the set of prepared and named profiles. Profiles may be selected e.g. during assignment procedure.

2. browsing through the set of options using hierarchical structure.

II. Starting a Game

After choosing procedure the system prepares the record in the database software for storage of all information about the current match.

III. Results Display and Input Interface

The current score is transmitted to the user device together with a page that allows user to easily input the consecutive events to the system such as scoring a point, getting a hole.

The current score is send to the user device using event queue mechanism.

The response page is constructed in such a way that one part of it is the current score for all users and the second provides an easy way to input data. For that purpose deck/card mechanism is used extensively. The most commonly choices are on the beginning of the first card (e.g score 1 point, score 2 points, score user #2).

The less used are located on the last positions and/or on the next cards. In this way the user in a normal game situation only moves cursor to the specified link and chooses it. When the device has a touch screen there is just one click to the specified option. When the particular link (leading to another deck) is chosen then user device sends a request to the scripting software, which updates the corresponding data in the database table.

Deck/Card Mechanism

As deck we understand the part of the single response from the server software, written in markup language and being a collection of cards. Card is a single unit of navigation and user interface, which may contain information present to the user, instructions for gathering input etc.

The advantage of such a structure is that the user may browse through separate cards within a single deck without initiating the connection to the server software. This way the user interface can be split to hierarchical menu, which navigation speed is most likely limited only by the user reaction.

Event Queue Mechanism

Because some of the protocols used for content transport media are connectionless, the system uses the following mechanism to push information to the wired or mobile user device.

1. Every event that concerns particular user (such as invitation to the game, scaring a point by the opponent, etc.) is stored in the event queue together with precise description and parameters of the event.

2. Server software for any request from the particular user checks if there is an event or more events for this user.

3. Server software takes an appropriate action suitable for the event and in particular adds additional content to the requested page and/or postpone actions requested by the user to the time of fulfilling the actions of the event.

4. The event in the event queue is then updated or removed

Normalised Score Concept

The concept allows competing with other players in different sport, different disciplines and different locations. The scoring system in particular sport is transformed into a set of rules which leads to the common progress indication. User, by completing the challenges and goals belonging to particular discipline gets some normalised points, which in turn may be used for totally discipline independent scoring. This way the opponent which have to accept the match settings is no longer needed. The rules and coefficients are related to the pair of disciplines and may be or may not be stored for particular two disciplines in normalisation table.

1. A system for a plurality of persons playing a game, the system comprising
a central data processing unit,
a portable communication unit for each person, each communication unit being adapted to receive game information and transmit this information to the central data processing unit,
the central data processing unit being adapted to transmit information received from one communication unit to at least one other of the communication units,
the central data processing unit being adapted to:
receive information from each of a number of persons relating to a desired starting point in time for a game, and
compare the received information and inform respective persons if a correspondence is found.

2. A system according to claim 1, wherein the portable communication units are adapted to provide to the central data processing unit information relating to a desired starting point in time for a game for a person and to receive from the central data processing unit information relating to another person wishing to play the game at at least approximately that point in time.

3. A system according to any of the preceding claims, wherein the information provided by the portable unit comprises additional information relating to the desired game or a desired other player of the game.

4. A system for a plurality of persons playing a (common) game, the system comprising
a central data processing unit,
a portable communication unit for each person or group of persons, each communication unit being adapted to receive game information and transmit this information to the central data processing unit,
the central data processing unit being adapted to transmit information received from one communication unit to at least one other of the communication units,
a portable communication unit being adapted to, before initiating a game or the taking part therein by a person or a group of persons, request the entering of starting information by the person or group of persons,
wherein a plurality of persons or a group of persons may play concurrently using the same communication unit by each person or group of persons entering non-identical starting information.

5. A system according to claim 4, wherein the starting data comprises a password.

6. A system for a plurality of persons playing a game, the system comprising
a central data processing unit,
a portable communication unit for each person or group of persons, each communication unit being adapted to receive game information and transmit this information to the central data processing unit,
the central data processing unit being adapted to, for each of a number of events of the game:
receive and process game information from the portable units,
determine one or more possible subsequent/next event(s) of the game and which person or persons may perform this/these events,
provide user interface data relating to this/these event(s), and
transmit, to at least one portable unit of the person or persons information relating to the possible next events, the user information enabling this/those portable unit(s) to:
illustrate to the person(s) the determined next/subsequent event(s) and to
receive, by a single push operation of a person, information relating to the actual next/subsequent event of the game and transmitting this game information to the central data processing unit.

7. A system according to claim 6, wherein the central data processing unit is further adapted to provide, with the data relating to a next/subsequent event, data relating to an actual score of the game.

8. A system according to claims 6 or 7, wherein the central data processing unit is adapted to transmit alternative information, such as an advertisement, to portable units not relating to the person(s) which may perform the next/subsequent event of the game.

9. A system according to any of the preceding claims, wherein the game information relates to events, such as changes in score, special penalties of a party, an order of finishing of parties, or end of time/period.

10. A system according to claim 9, wherein the game information further relates to circumstances of the change, such as an identification of the player having scored, identification of the manner of scoring, such as penalty kick in soccer, hole-in-one, ball-in-bunker, ball-on-green.

11. A system according to any of the preceding claims, wherein the central data processing unit is further adapted to store received game information.

12. A system according to claim 11, wherein the central data processing unit is further adapted to provide statistical information relating to game information relating to a game, a person, a group of persons, or a playground or an arena.

13. A system according to claim 11, wherein the central data processing unit is further adapted to retrieve and transmit stored game information relating to an earlier game.

14. A system according to claim 11, wherein the central data processing unit is further adapted to transmit game information to additional receivers, such as a PC, palm pilots, or mobile telephones.

15. A mobile communication unit for use in the system according to any of the preceding claims, the unit comprising:
means for entering and transmitting game information to the central data processing unit,
means for receiving and displaying information from the central data processing unit

16. A unit according to claim 15, further comprising:
means for entering and transmitting information relating to a desired starting point in time for a game, and
means for receiving information from the central data processing unit relating to whether another communication unit/user has desired a game at at least approximately that point in time.

17. A unit according to claim 15 or 16, wherein the unit is additionally adapted to receive and display additional information, such as advertisements.

18. A unit according to claim 17, wherein the unit is adapted to display the advertisement in a predetermined period of time.

19. A unit according to any of claims 16-18, wherein the unit is adapted to have information entered by a single button push.
